(19) United States
(12) Patent Application Publication
(10) Pub. No.: US 2008/0174807 A1
(43) Pub. Date: Jul. 24, 2008

(54) SYSTEM AND METHOD FOR PREVIEW OF DOCUMENT PROCESSING MEDIA

(76) Inventors: Truc Nguyen, San Diego, CA (US); William Su, Riverside, CA (US); John Garred, Brecksville, OH (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/626,807

(22) Filed: Jan. 24, 2007

(51) Int. Cl. G06F 3/12; G06F 17/00

(52) U.S. Cl. 358/1.15; 715/273; 715/274

(57) ABSTRACT

The subject application is directed to a system and method for previewing document processing media. Image data representing a sheet medium on which rendering of an associated electronic document is available is first received. Next, a visual representation of at least a portion of the sheet medium is generated on a display based upon the received image data. Selection data is then received corresponding to a selection of a document processing operation that is targeted for the sheet medium according to the generated visual representation. A document processing operation is then commenced, which results in the rendering on the sheet medium of the associated electronic document.

### BACKGROUND OF THE INVENTION

The subject application is directed to a system and method for previewing document processing media. In particular, the subject application is directed to a system and method for selecting a tangible output source for a document processing operation based on displayed image data of selected output mediums. The subject application allows a user to select an appropriate output source for special document processing operations based on an image or picture of available output sources.

A user of a document processing device, such as a multifunctional peripheral device, will occasionally need to generate a document processing job on a special type of output medium or paper source, such as company letterhead, form sheets, colored paper, music staff paper, graph paper, or the like. In current document processing devices, the user selects the paper source or type based on a verbal description of the paper source. While user selection of an appropriate output source based on a verbal description is generally acceptable for a selection of an output source based on size, such selection process is not acceptable for selection based on a type of form or color.

Once the user has selected the appropriate output source, the user must then ensure that the proper source is loaded into the proper output tray. The user must then either request that other users do not use the document processing device until the user has completed the job or must quickly submit the job for processing before another user submits a job. To overcome this situation, some document processing devices provide for the user to submit a private document processing job wherein the user ensures that the appropriate output source is available prior to releasing the job at the device for processing. Another option is for the user to reserve an output tray for a specific time or document processing job.

The forgoing is very difficult in a shared peripheral environment, such as in an office where multiple users share a single document processing device. It is particularly difficult when such device is remote from a user's workstation, such as when it's located in a common location, such as a hallway. In such situations, a user may have changed trays, placed different paper into a tray, or inserted a form or letterhead for use in a job prior to having started a document processing operation. In such a situation, another user could start a print job, and find that it ended up on letterhead, wasting a document processing operation, operator time, and paper.

It would be desirable to have a system and method that allowed a user to view the actual paper or other medium that will be used next for a document processing operation, such as printing, and avoid the waste of time, toner and paper associated with unexpected media being present.

### SUMMARY OF THE INVENTION

In accordance with the subject application, there is provided a system and method for previewing document processing media.

Further, in accordance with the subject application, there is provided a system and method for selecting a tangible output source for a document processing operation based on displayed image data of selected output mediums.

Further, in accordance with the subject application, there is provided a system and method that allows a user to select an appropriate output source for special document processing operations based on an image or picture of available output sources.

Still further, in accordance with the subject application, there is provided a system for previewing document processing media. The system includes means adapted for receiving image data representative of an image of a sheet medium available for rendering of an associated electronic document and display means adapted for generating a visual representation of at least a portion of the sheet medium on an associated display in accordance with received image data. The system further includes selection means adapted for receiving selection data representative of a selection of a document processing operation targeted for the sheet medium in accordance with a generated visual representation thereof and means adapted for commencing a document processing operation wherein the associated electronic document is rendered on the sheet medium.

In one embodiment, the system further comprises image capture means adapted for capturing the image data from the sheet medium which will be processed first from a plurality thereof upon commencement of the document processing operation.

In another embodiment, the system further includes means adapted for receiving image data corresponding to each of a plurality of sheet media available for rendering of the associated electronic document. In this embodiment, the display means includes means adapted for generating a visual representation of each of the plurality of sheet media on the associated display and the selection means includes means adapted for receiving selection data of a document processing operation targeted for a sheet medium selected from the display.

In a further embodiment, the image data includes data indicative of a visual indicator of at least one attribute from the set of watermark, letterhead, media color, media orientation, preprinted text, preprinted graphic and media stock.

In yet another embodiment, the system further comprises means adapted for communicating image data, via a network, to the associated display, which associated display is comprised of a thin client of a networked data processing device.

In another embodiment, the selection means includes a user interface associated with the thin client.

Still further, in accordance with the subject application, there is provided a method for previewing document processing media in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the system for previewing document processing media according to the subject application;

FIG. 2 is a block diagram illustrating a paper storage tray for use in the system for previewing document processing media according to the subject application;

FIG. 3 is a block diagram illustrating controller hardware for use in the system for previewing document processing media according to the subject application;

FIG. 4 is a functional diagram illustrating the controller for use in the system for previewing document processing media according to the subject application;

FIG. 5 is a flowchart illustrating a method for previewing document processing media according to the subject application; and

FIG. 6 is a flowchart illustrating a method for previewing document processing media according to the subject application.

### DETAILED DESCRIPTION OF THE PREFERRED EMBODIMENT

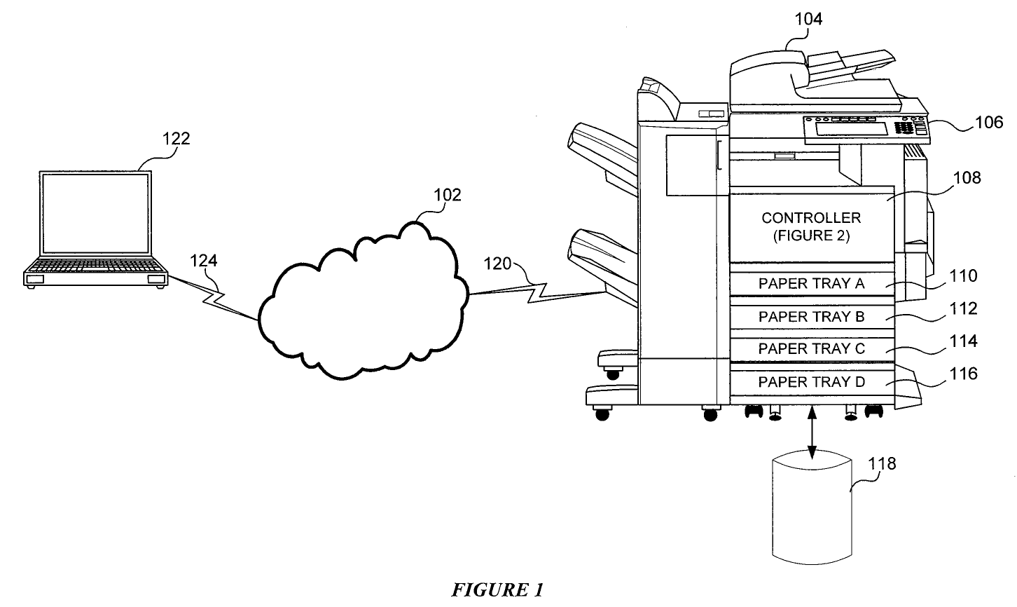

The subject application is directed to a system and method for previewing document processing media. In particular, the subject application is directed to a system and method for selecting a tangible output source for a document processing operation based on displayed image data of selected output mediums. More particularly, the subject application is directed to a system and method that allows a user to select an appropriate output source for special document processing operations based on an image or picture of available output sources. It will become apparent to those skilled in the art that the system and method described herein are suitably adapted to a plurality of varying electronic fields employing user interfaces, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of the system 100 for previewing document processing media in accordance with the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 120. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

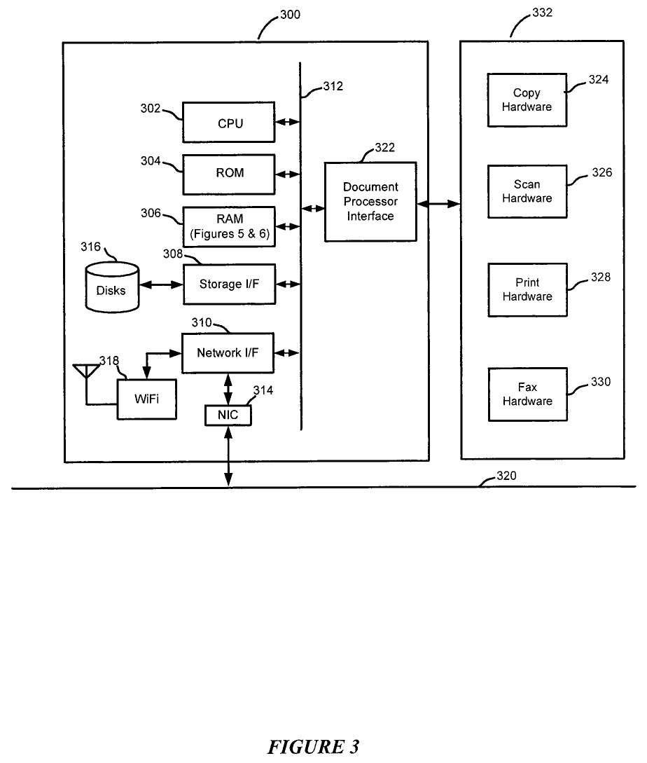

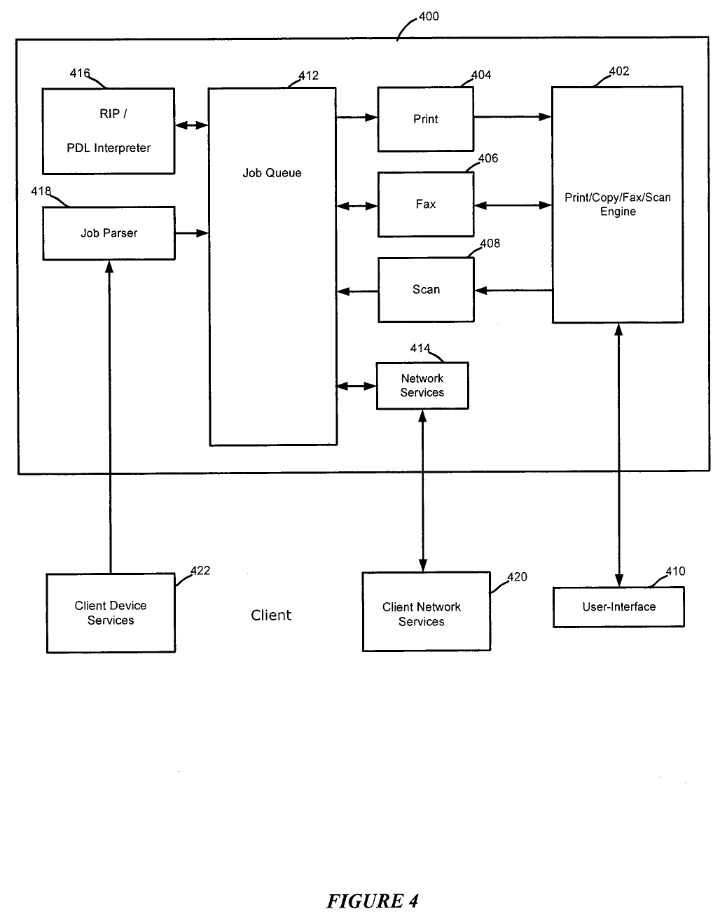

In accordance with the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for previewing document processing media of the subject application. The functioning of the controller 108 will better be understood in conjunction with the block diagrams illustrated in FIGS. 3 and 4, explained in greater detail below.

Communicatively coupled to the document processing device 104 is a data storage device 118. In accordance with the preferred embodiment of the subject application, the data storage device 118 is any mass storage device known in the art including, for example and without limitation, magnetic storage drives, a hard disk drive, optical storage devices, flash memory devices, or any suitable combination thereof. In the preferred embodiment, the data storage device 118 is suitably adapted to store a document data, image data, electronic database data, or the like. It will be appreciated by those skilled in the art that while illustrated in FIG. 1 as being a separate component of the system 100, the data storage device 118 is capable of being implemented as internal storage component of the document processing device 104, a component of the controller 108, or the like, such as, for example and without limitation, an internal hard disk drive, or the like. In accordance with one embodiment of the subject application, the data storage device 118 includes an electronic database containing electronic data representative of each sheet of output media available at the associated document processing device 104. Preferably, the electronic data comprises images indicative of a visual indicator of an attribute associated with the sheet, e.g., a watermark, letterhead, media color, media orientation, preprinted text, preprinted graphic, media stock, a form, or the like, which represent the sheets of output media on which rendering by the document processing device 104 is capable of being performed.

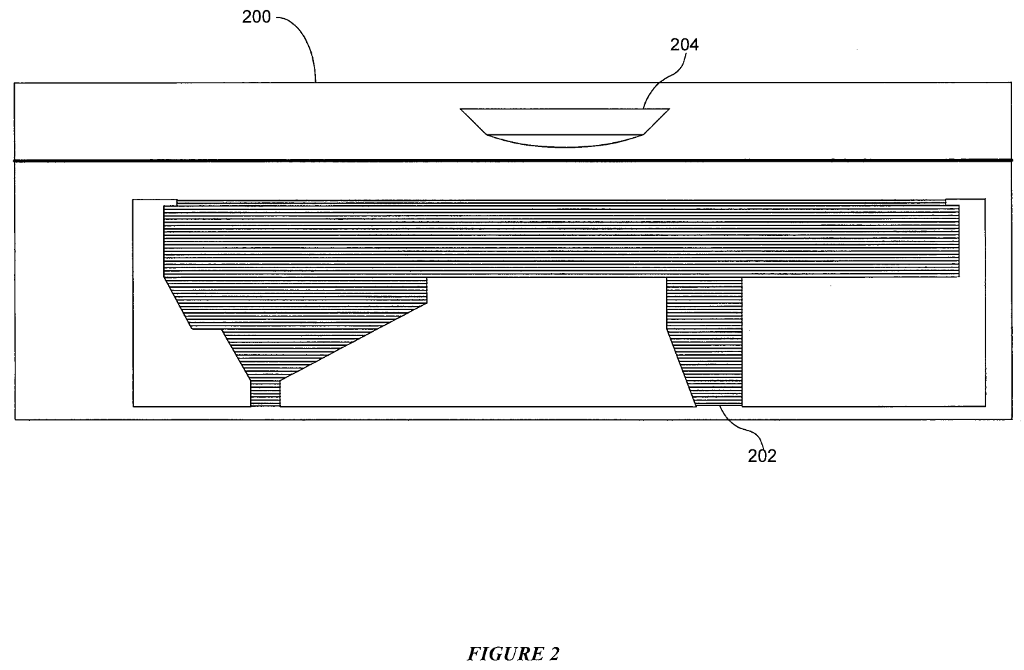

The document processing device 104 of the system 100 depicted in FIG. 1 further includes one or more sheet media storage locations, output media storage, or paper trays. For purposes of explanation hereinafter, the term “paper tray” references those storage locations on the document processing device 104 containing output media on which rendering is capable of being performed. As will be understood by those skilled in the art, the paper trays, shown as paper tray A 110, paper tray B 112, paper tray C 114, and paper tray D 116 are suitably adapted to store one or more sheets of output media upon which an electronic document is to be rendered. For example, as the skilled artisan will appreciate, the paper tray A 110 suitably stores standard letter size sheets of paper, such as 8.5×11 inch-paper, whereas the paper tray B 112 stores A4 paper, the paper tray C 114 stores letterhead 8.5×11 inch-paper, the paper tray D 116 stores accounting form paper, or the like. It will be understood by those skilled in the art that the foregoing descriptions of the contents of the paper trays 110-116 are for illustration purposes only and the subject application is not limited to these output medium types. In addition, the skilled artisan will appreciate that the document processing device 104 is not limited to four paper trays 110-116, but rather is capable of including any number of paper trays, as known in the art. The paper trays 110-116 will be explained in greater detail below with respect to FIG. 2.

The system 100 illustrated in FIG. 1 further depicts a user device 122, in data communication with the computer network 102 via a communications link 124. It will be appreciated by those skilled in the art that the user device 122 is shown in FIG. 1 as a laptop computer for illustration purposes only. As will be understood by those skilled in the art, the user device 122 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 124 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 122 is suitably adapted to generate and transmit electronic documents, document processing instructions, user interface modifications, upgrades, updates, personalization data, or the like, to the document processing device 104, or any other similar device coupled to the computer network 102.

FIG. 2 illustrates an example embodiment of a paper tray 110-116 for use in the system for previewing document processing media in accordance with the subject application. As shown in FIG. 2, a paper tray 200 is suitably adapted to store one or more sheets of output media 202 therein. Preferably, the document processing device 104 is suitably adapted to retrieve one or more sheets of output media 202 from the paper tray 200 during document processing operations requiring the output of hardcopies. In accordance with one particular embodiment of the subject application, the paper tray 200 further includes one or more image capture devices, shown in FIG. 2 as the capture device 204. Suitable capture devices include, for example and without limitation, webcams, video cameras, still-image cameras, or other image capturing devices as are known in the art. Preferably, the capture device 204 is communicatively coupled to the controller 108 of FIG. 1, thereby enabling the controller 108 to facilitate image analysis operations on the media stored in the paper tray 200. Further operations of the capture device 204 will be explained in greater detail below.

Turning now to FIG. 3, illustrated is a representative architecture of a suitable backend component, i.e., the controller 300, shown in FIG. 1 as the controller 108, on which operations of the subject system 100 are completed. The skilled artisan will understand that the controller 108 is representative of any general computing device, known in the art, capable of facilitating the methodologies described herein. Included is a processor 302, suitably comprised of a central processor unit. However, it will be appreciated that processor 302 may advantageously be composed of multiple processors working in concert with one another as will be appreciated by one of ordinary skill in the art. Also included is a non-volatile or read only memory 304 which is advantageously used for static or fixed data or instructions, such as BIOS functions, system functions, system configuration data, and other routines or data used for operation of the controller 300.

Also included in the controller 300 is random access memory 306, suitably formed of dynamic random access memory, static random access memory, or any other suitable, addressable and writable memory system. Random access memory provides a storage area for data instructions associated with applications and data handling accomplished by processor 302.

A storage interface 308 suitably provides a mechanism for non-volatile, bulk or long term storage of data associated with the controller 300. The storage interface 308 suitably uses bulk storage, such as any suitable addressable or serial storage, such as a disk, optical, tape drive and the like as shown as 316, as well as any suitable storage medium as will be appreciated by one of ordinary skill in the art.

A network interface subsystem 310 suitably routes input and output from an associated network allowing the controller 300 to communicate to other devices. Network interface subsystem 310 suitably interfaces with one or more connections with external devices to the device 300. By way of example, illustrated is at least one network interface card 314 for data communication with fixed or wired networks, such as Ethernet, token ring, and the like, and a wireless interface 318, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 314 is interconnected for data interchange via a physical network 320, suitably comprised of a local area network, wide area network, or a combination thereof.

Data communication between the processor 302, read only memory 304, random access memory 306, storage interface 308 and network interface subsystem 310 is suitably accomplished via a bus data transfer mechanism, such as illustrated by bus 312.

Also in data communication with the bus 312 is a document processor interface 322. The document processor interface 322 suitably provides connection with hardware 332 to perform one or more document processing operations. Such operations include copying accomplished via copy hardware 324, scanning accomplished via scan hardware 326, printing accomplished via print hardware 328, and facsimile communication accomplished via facsimile hardware 330. It is to be appreciated that a controller suitably operates any or all of the aforementioned document processing operations. Systems accomplishing more than one document processing operation are commonly referred to as multifunction peripherals or multifunction devices.

Functionality of the subject system 100 is accomplished on a suitable document processing device 104 that includes the controller 300 of FIG. 3, (shown in FIG. 1 as the controller 108), as an intelligent subsystem associated with a document processing device. In the illustration of FIG. 4, controller function 400 in the preferred embodiment includes a document processing engine 402. A suitable controller functionality is that incorporated into the Toshiba e-Studio system in the preferred embodiment. FIG. 4 illustrates suitable functionality of the hardware of FIG. 3 in connection with software and operating system functionality as will be appreciated by one of ordinary skill in the art.

In the preferred embodiment, the engine 402 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 402 is suitably interfaced to a user interface panel 410, which panel allows for a user or administrator to access functionality controlled by the engine 402. Access is suitably enabled via an interface local to the controller, or remotely via a remote thin or thick client.

The engine 402 is in data communication with print function 404, facsimile function 406, and scan function 408. These functions facilitate the actual operation of printing, facsimile transmission and reception, and document scanning for use in securing document images for copying or generating electronic versions.

A job queue 412 is suitably in data communication with the printer function 404, facsimile function 406, and scan function 408. It will be appreciated that various image forms, such as bit map, page description language or vector format, and the like, are suitably relayed from the scan function 408 for subsequent handling via the job queue 412.

The job queue 412 is also in data communication with network services 414. In a preferred embodiment, job control, status data, or electronic document data is exchanged between the job queue 412 and the network services 414. Thus, suitable interface is provided for network based access to the controller 400 via client side network services 420, which is any suitable thin or thick client. In the preferred embodiment, the web services access is suitably accomplished via a hypertext transfer protocol, file transfer protocol, uniform data diagram protocol, or any other suitable exchange mechanism. The network services 414 also advantageously supplies data interchange with the client side services 420 for communication via FTP, electronic mail, TELNET, or the like. Thus, the controller function 400 facilitates output or receipt of electronic document and user information via various network access mechanisms.

The job queue 412 is also advantageously placed in data communication with an image processor 416. The image processor 416 is suitably a raster image process, page description language interpreter or any suitable mechanism for interchange of an electronic document to a format better suited for interchange with device functions such as print 404, facsimile 406 or scan 408.

Finally, the job queue 412 is in data communication with a parser 418, which parser suitably functions to receive print job language files from an external device, such as client device services 422. Client device services 422 suitably include printing, facsimile transmission, or other suitable input of an electronic document for which handling by the controller function 400 is advantageous. The parser 418 functions to interpret a received electronic document file and relay it to the job queue 412 for handling in connection with the afore-described functionality and components.

In operation, image data representing a sheet medium on which rendering of an associated electronic document is available is first received. A visual representation of a portion of the sheet is then generated on a display in accordance with the received image data. Selection data is then received representing a selection of a document processing operation targeted for the sheet medium. A document processing operation is then commenced resulting in the rendering of the electronic document on the sheet medium.

In accordance with one example embodiment of the subject application, a new output medium 202 is inserted into a paper tray, e.g., the paper tray A 110. An image of the new medium 202 is captured by the capture device 204, which is located in proximity to the paper tray A 110. It will be appreciated by those skilled in the art that the capture device 204 is capable of being affixed to the paper tray A 110 itself, attached to the document processing device 104 independent of the paper tray A 110 being monitored, or the like. The image data is then stored in association with its actual physical location, i.e., the paper tray A 110, in a database on the data storage device 118.

Upon receipt of a document processing request from an associated user, images of all media available for rendering by the document processing device 104 are retrieved from the database on the data storage device 118. It will be appreciated by those skilled in the art that the use of the database on the storage device 118 is for example purposes only and the subject application is capable of real-time implementation. That is, upon selection by a user of a document processing operation, the document processing device 104 generates an image of each output media in the paper trays 110-116. An image of the selected media is then stored in temporary memory associated with the document processing device 104 for comparison with additional pages of an output document. Thus, real-time implementation of the subject application is capable of being realized.

The images retrieved from the database are then displayed via the user interface 106 associated with the document processing device 104 to an associated user. The images displayed to the user via the user interface 106 are capable of including, for example and without limitation, a visual indicator of an attribute associated with the media, a thumbnail view of the media, or the like. Suitable visual indicators include, for example and without limitation, a watermark, letterhead, media orientation, media color, preprinted text, a form, preprinted graphic, media stock, or the like. In accordance with one embodiment of the subject application, the image data is communicated via the computer network 102 to a thin client (not shown) associated with the user device 122 or other data processing device communicatively coupled to the computer network 102. Thus, the skilled artisan will appreciate that the subject application is capable of implementation remotely, enabling a user associated with the user device 122 to select an output media from a display via a thin client associated therewith.

The user then selects a desired output medium based upon those images displayed via the associated user interface 106. The selected document processing operation is then commenced with rendering intended for completion using the selected output medium. The controller 108 or other suitable component of the document processing device 104 then initiates a scan of the storage location, as determined from the paper tray stored in association with the medium in the database, corresponding to the selected output medium. Thus, the paper tray A 110 is scanned by the capture device 204 to determine whether the first sheet of the medium stored in the paper tray A 110 matches the image the user selected. When no image match is found in the paper tray A 110, the controller 108 or other suitable component of the document processing device 104 initiates scanning of each additional storage location, i.e., the paper tray B 112, paper tray C 114, paper tray D 116, etc. When the selected output medium is located, the tray in which it is located is designated as the default output media source for the requested document processing operation. The first page of an electronic document corresponding to the document processing request is then output using the first sheet from the default tray. When the first sheet of output medium in the paper tray A 110 matches the image selected by the user, the paper tray A 110 is designated as the default tray for the document processing operation. The first page of the electronic document associated with the document processing request is then output by the document processing device 104 using the first sheet in the default tray.

When no additional sheets, or pages, of the electronic document remain to be output, the document processing operation terminates. When one or more additional pages remain to be output, the capture device 204 captures an image of the top sheet of output medium in the default tray. That is, the capture device 204 captures an image of the next sheet of paper in the default tray remaining after the preceding page has been removed and used for rendering in the document processing operation. A determination is then made whether the image just captured by the image capture device 204 matches the image selected by the user as the output medium. When there is a match, the operation proceeds as described above, with the document processing device 104 rendering the next page of the electronic document on this top sheet. When no match is found in the default tray, each additional paper tray is scanned for the selected medium. When no match is found in any of the paper trays, the user is notified of the lack of the selected medium. When the selected output medium is located in another paper tray, e.g., the paper tray D 116 instead of the paper tray A 110, the paper tray D 116 is designated as the default output media source, i.e., default paper tray, and the document processing operation is performed thereafter on the top sheet of the output medium in the paper tray D 116. The skilled artisan will appreciate that this process repeats for each additional page of the electronic document until all pages have been suitably rendered on the selected output medium. The skilled artisan will further appreciate that the subject application is capable of dynamically changing the default output medium source among the associated paper trays 110-116 based upon the image returned by the capture device 204.

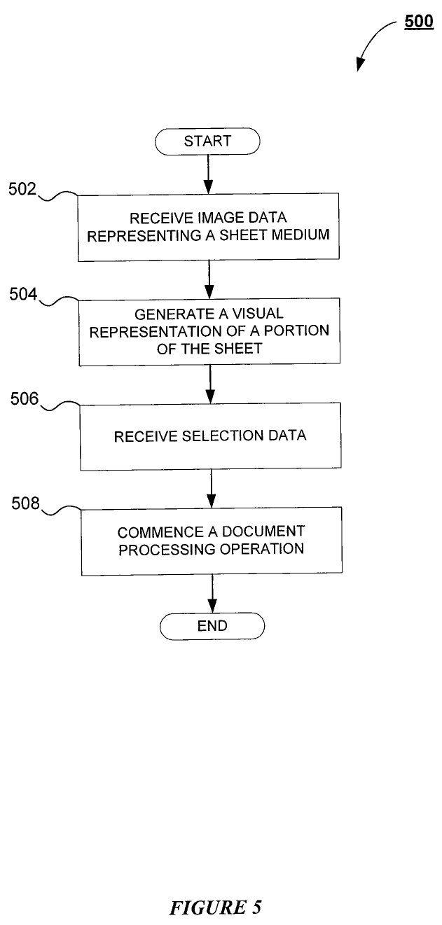

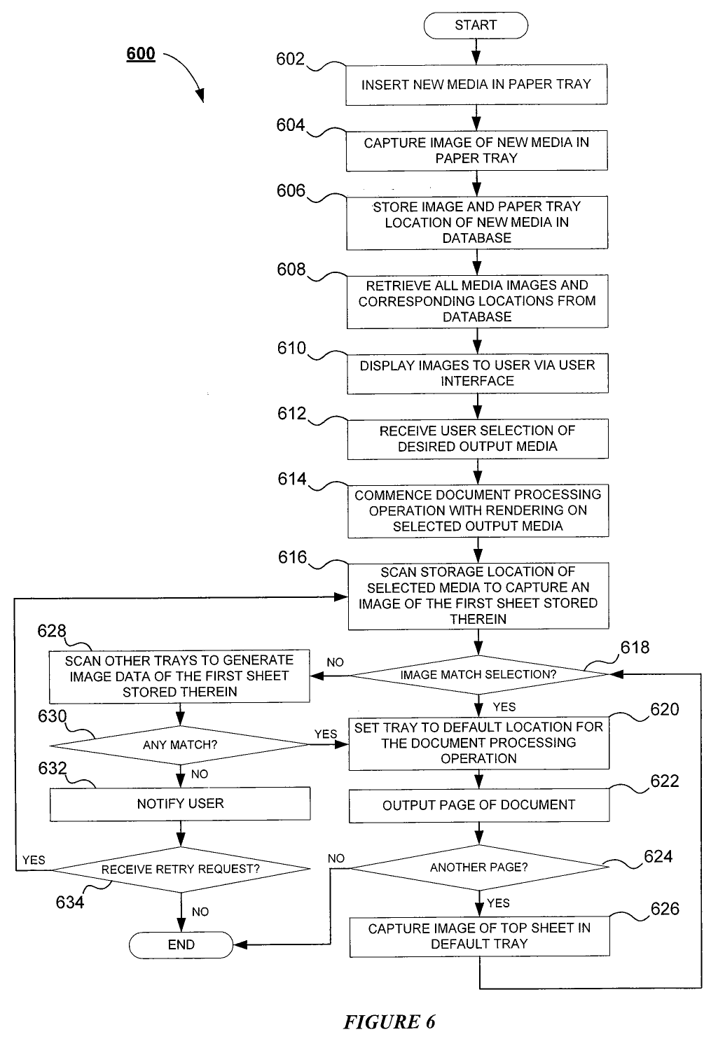

The skilled artisan will appreciate that the subject system 100 and components described above with respect to FIG. 1, FIG. 2, FIG. 3, and FIG. 4 will be better understood in conjunction with the methodologies described hereinafter with respect to FIG. 5 and FIG. 6. Turning now to FIG. 5, there is shown a flowchart 500 illustrating a method for previewing document processing media in accordance with the subject application. Beginning at step 502, image data representing a sheet medium on which rendering of an associated electronic document is available is first received. Next, at step 504 a visual representation of at least a portion of the sheet medium is generated on a display based upon the received image data. Selection data is then received at step 506 corresponding to a selection of a document processing operation that is targeted for the sheet medium according to the generated visual representation. A document processing operation is then commenced at step 508 resulting in the rendering on the sheet medium of the associated electronic document.

Referring now to FIG. 6, there is shown a flowchart 600 illustrating a method for previewing document processing media in accordance with the subject application. Operations in the example embodiment of FIG. 6 include reference to a database stored on the data storage device 118, however it will be appreciated by those skilled in the art that the use of the database on the storage device 118 is for example purposes only and the subject application is capable of real-time implementation. That is, upon selection by a user of a document processing operation, the document processing device 104 generates an image of each output media in the paper trays 110-116. An image of the selected media is then stored in temporary memory associated with the document processing device 104 for comparison with additional pages of an output document. Thus, real-time implementation of the subject application is capable of being realized.

The flowchart 600 of FIG. 6 begins at step 602 with the loading of a new output media into a paper tray. For purposes of example only, the new output media is loaded into the paper tray A 110, however the skilled artisan will appreciate that any paper tray B 112, C 114, or D 116 is capable of receiving the new output media. Flow then proceeds to step 604, whereupon an image capture device 204 associated with the paper tray A 110 captures an image of all or a portion of the top sheet of the new media that has been inserted therein. The image of the new media, as well as the storage location, i.e., the paper tray A 110, are then stored in association with each other in the database on the data storage device 118 at step 606.

Upon initiation of a document processing operation, such as for example and without limitation a print operation, a copy operation, the receipt of an electronic document, or the like, images corresponding to available output media are retrieved from the database at step 608. The retrieved images are then displayed, at step 610, to a user via a display associated with the user interface 106. The skilled artisan will appreciate that in accordance with one embodiment of the subject application, the initiation of the document processing operation is capable of originating via a thin client interface operative remotely at the user device 122. Such an initiation would therefore prompt the display of the images of the media by the thin client associated with the user device 122. The associated user then makes a selection of a desired output media, which is received at step 612. Preferably, the user selects one of the images from those displayed, either via the user interface 106 or the user device 122, for rendering of an electronic document in accordance with the initiated document processing operation. The document processing device 104 then commences the requested document processing operation with rendering on the selected output media at step 614.

At step 616, the controller 108 or other suitable component of the document processing device 104, determines the storage location, i.e., the paper tray 110-116, in which the selected output media is located and initiates a scan of the top sheet of the output media stored therein. Preferably, the storage location is determined based upon data retrieved from the database based upon the image selected by the user of the output media. Image data of the first sheet in the designated storage location, i.e., the paper tray A 110, is then compared with the image data stored in the database at step 618 to determine whether the output media in the paper tray matches the media selected by the user. When output media in the designated the paper tray A 110 matches the selected image, flow proceeds to step 620, whereupon the paper tray A 110 is set as the default paper source for the current document processing operation. Thereupon, the first page of the electronic document is suitably rendered on the first sheet in the paper tray A 110 and output at step 622. A determination is then made at step 624 whether the electronic document contains an additional page. When no additional pages remain for output, the current document processing operation terminates.

When an additional page remains to be output in the current document processing operation, operations proceed to step 626, whereupon an image of the top sheet of the default paper tray A 110 is captured. The skilled artisan will appreciate that after output of the first page of the electronic document, the controller 108 or other suitable component of the document processing device 104 is capable of determining whether the next piece of output media matches the selected output media. Thus, flow returns from step 626 to step 618, whereupon a determination is made whether the image captured at step 626 matches the image selected by the user. When the images correlate, operations continue from step 620 to step 626 as set forth above.

In the event that the image captured at step 626, as determined at step 618, do not match, i.e., the next sheet of paper in the paper tray A 110 is not the selected paper type, flow proceeds to step 628. At step 628, the remaining output media source storage locations, i.e., the paper tray B 112, paper tray C 114, and the paper tray D 116 are scanned, resulting in the generation of image data corresponding to the top sheets of output media in each tray. It will be appreciated by those skilled in the art that for purposes of brevity, remaining paper trays 112-116 are concurrently scanned, however each operation is capable of being performed individually such that a complete process is performed for a single tray before proceeding to the next tray. Steps 618-626 are suitably implemented thereon in the single tray analysis. Returning to the preferred embodiment, after generating images of the top sheets of each paper tray 112-116, flow proceeds to step 630, whereupon a determination is made whether the top sheet in any of the remaining trays 112-116 matches the selected output media. In the event a match is determined, flow proceeds to step 620, whereupon that tray, e.g., the paper tray B 112, is set as the default output media source for the remaining pages of the current document processing operation. The second page of the document is then output at step 622 and a determination is made at step 624 whether an additional page remains to be output. When no matches are determined at step 630, flow proceeds to step 632, whereupon the user is notified that no media matching the requested media is available at the document processing device 104. The skilled artisan will appreciate that the user is then able to load additional output media in one of the paper trays 110-116 and continue by requesting a retry. When such a retry request is received at step 634, flow returns to step 616, whereupon the designated storage location is scanned to capture an image of the media stored therein. Operations continue as set forth above until the current document processing operation has been completed, or until such time as no retry request is received.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for previewing document processing media comprising:
means adapted for receiving image data representative of an image of a sheet medium available for rendering of an associated electronic document;
display means adapted for generating a visual representation of at least a portion of the sheet medium on an associated display in accordance with received image data;
selection means adapted for receiving selection data representative of a selection of a document processing operation targeted for the sheet medium in accordance with a generated visual representation thereof; and
means adapted for commencing a document processing operation wherein the associated electronic document is rendered on the sheet medium.

2. The system for previewing document processing media of claim 1 further comprising image capture means adapted for capturing the image data from the sheet medium which will be processed first from a plurality thereof upon commencement of the document processing operation.

3. The system for previewing document processing media of claim 2 further comprising:
means adapted for receiving image data corresponding to each of a plurality of sheet media available for rendering of the associated electronic document; and wherein:
the display means includes means adapted for generating a visual representation of each of the plurality of sheet media on the associated display; and
the selection means includes means adapted for receiving selection data of a document processing operation targeted for a sheet medium selected from the associated display.

4. The system for previewing document processing media of claim 1 wherein the image data includes data indicative of a visual indicator of at least one attribute from the set of watermark, letterhead, media color, media orientation, preprinted text, preprinted graphic and media stock.

5. The system for previewing document processing media of claim 2 further comprising means adapted for communicating image data, via a network, to the associated display, which associated display is comprised of a thin client of a networked data processing device.

6. The system for previewing document processing media of claim 5 wherein the selection means includes a user interface associated with the thin client.

7. A method for previewing document processing media comprising the steps of:
receiving image data representative of an image of a sheet medium available for rendering of an associated electronic document;
generating a visual representation of at least a portion of the sheet medium on an associated display in accordance with received image data;
receiving selection data representative of a selection of a document processing operation targeted for the sheet medium in accordance with a generated visual representation thereof; and
commencing a document processing operation wherein the associated electronic document is rendered on the sheet medium.

8. The method for previewing document processing media of claim 7 further comprising the step of capturing the image data from the sheet medium which will be processed first from a plurality thereof upon commencement of the document processing operation.

9. The method for previewing document processing media of claim 8 further comprising the steps of:
receiving image data corresponding to each of a plurality of sheet media available for rendering of the associated electronic document;
generating a visual representation of each of the plurality of sheet media on the associated display; and
receiving selection data of a document processing operation targeted for a sheet medium selected from the display.

10. The method for previewing document processing media of claim 7 wherein the image data includes data indicative of a visual indicator of at least one attribute from the set of watermark, letterhead, media color, media orientation, preprinted text, preprinted graphic and media stock.

11. The method for previewing document processing media of claim 8 further comprising the steps of:
communicating image data, via a network, to the associated display; and
generating the visual representation on a thin client of a networked data processing device.

12. The method for previewing document processing media of claim 11 wherein the step of receiving selection data is via a user interface associated with the thin client.

13. A computer-implemented method for previewing document processing media comprising the steps of:
receiving image data representative of an image of a sheet medium available for rendering of an associated electronic document;
generating a visual representation of at least a portion of the sheet medium on an associated display in accordance with received image data;
receiving selection data representative of a selection of a document processing operation targeted for the sheet medium in accordance with a generated visual representation thereof; and
commencing a document processing operation wherein the associated electronic document is rendered on the sheet medium.

14. The computer-implemented method for previewing document processing media of claim 13 further comprising the step of capturing the image data from the sheet medium which will be processed first from a plurality thereof upon commencement of the document processing operation.

15. The computer-implemented method for previewing document processing media of claim 14 further comprising the steps of:
receiving image data corresponding to each of a plurality of sheet media available for rendering of the associated electronic document;
generating a visual representation of each of the plurality of sheet media on the associated display; and
receiving selection data of a document processing operation targeted for a sheet medium selected from the display.

16. The computer-implemented method for previewing document processing media of claim 13 wherein the image data includes data indicative of a visual indicator of at least one attribute from the set of watermark, letterhead, media color, media orientation, preprinted text, preprinted graphic and media stock.

17. The computer-implemented method for previewing document processing media of claim 14 further comprising the steps of:
communicating image data, via a network, to the associated display; and
generating the visual representation on a thin client of a networked data processing device.

18. The computer-implemented method for previewing document processing is media of claim 17 wherein the step of receiving selection data is via a user interface associated with the thin client.
